(19) United States
(12) Patent Application Publication
(10) Pub. No.: US 2022/0412443 A1
(43) Pub. Date: Dec. 29, 2022

(54) ACTUATOR

(71) Applicant: DENSO CORPORATION, Kariya-city (JP)

(72) Inventors: Naoaki KOUNO, Kariya-city (JP); Tetsuji YAMANAKA, Kariya-city (JP); Masashi YAMAGUCHI, Kariya-city (JP)

(21) Appl. No.: 17/899,123

(22) Filed: Aug. 30, 2022

Related U.S. Application Data
(63) Continuation of application No. PCT/JP2021/006378, filed on Feb. 19, 2021.

(30) Foreign Application Priority Data
Mar. 3, 2020 (JP) 2020-036011

(51) Int. Cl. F16H 37/12; F02B 37/16; F16H 55/06; F16H 55/17; F16K 31/53

(52) U.S. Cl. CPC F16H 37/122; F02B 37/16; F16H 55/06; F16H 55/17; F16K 31/535; F16H 2055/065

(57) ABSTRACT

A gear of a speed reducer of an actuator includes: an insert component; a center portion; an outer peripheral portion; a connecting portion; a gate mark; a weld-line portion; and a rib-shaped portion. The center portion surrounds the insert component. The outer peripheral portion includes a toothed portion and a toothless portion. The weld-line portion is formed in at least one of the center portion, the connecting portion and the outer peripheral portion at a location which is on a radially inner side of the toothless portion. The rib-shaped portion is formed in at least one of the center portion, the connecting portion and the outer peripheral portion at a location which includes the weld-line portion. The rib-shaped portion has a wall thickness that is larger than a wall thickness of another circumferential portion.

### CROSS REFERENCE TO RELATED APPLICATIONS

This application is a continuation application of International Patent Application No. PCT/JP2021/006378 filed on Feb. 19, 2021, which designated the U.S. and claims the benefit of priority from Japanese Patent Application No. 2020-36011 filed on Mar. 3, 2020. The entire disclosures of all of the above applications are incorporated herein by reference.

### TECHNICAL FIELD

The present disclosure relates to an actuator.

### BACKGROUND

Previously, there has been proposed an actuator where a torque generated by a drive device is transmitted to a driven body through a speed reducer to drive the driven body. A speed reducer of one such actuator includes a gear made of resin. In this gear, a weld-line portion, at which flows of molten resin meet at a time of resin injection molding, is formed in a toothless portion without forming the weld-line portion in a toothed portion, so that the strength of the toothed portion is increased.

### SUMMARY

This section provides a general summary of the disclosure, and is not a comprehensive disclosure of its full scope or all of its features.

According to the present disclosure, there is provided an actuator that includes a speed reducer configured to output a drive force generated through rotation by a drive device after reducing a rotational speed of the rotation outputted from the drive device. The speed reducer includes at least a gear that is formed by resin injection molding. The gear has a center portion, an outer peripheral portion, a connecting portion and a rib-shaped portion. The connecting portion connects between the center portion and the outer peripheral portion. The rib-shaped portion is formed in at least one of the center portion, the connecting portion and the outer peripheral portion. The rib-shaped portion has a wall thickness that is larger than a wall thickness of another circumferential portion which is other than the rib-shaped portion and is located on a side of the rib-shaped portion in a circumferential direction.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram of an intake and exhaust system of an engine, to which an actuator of a first embodiment is applied.

FIG. 2 is an external view of a supercharger including a cross-section of a bypass passage.

FIG. 3 is a plan view showing respective gears of a speed reducer in a state where a housing cover of an actuator is removed.

FIG. 4 is a cross-sectional view taken along line IV-IV in FIG. 3 including the housing cover of the actuator.

FIG. 5 is a perspective view of an output gear of the first embodiment.

FIG. 6 is an enlarged view of a portion VI in FIG. 5.

FIG. 7 is a plan view of the output gear of the first embodiment.

FIG. 8 is a side view seen in a direction of an arrow VIII in FIG. 7.

FIG. 9 is a cross-sectional view taken along the line IX-IX in FIG. 7.

FIG. 10 is an explanatory diagram for explaining how molten resin is filled at a time of resin injection molding of the output gear of the first embodiment.

FIG. 11 is an explanatory diagram for explaining how the molten resin is filled at the time of the resin injection molding of the output gear of the first embodiment following a state shown in FIG. 10.

FIG. 12 is an explanatory diagram for explaining how the molten resin is filled at the time of the resin injection molding of the output gear of the first embodiment following a state shown in FIG. 11.

FIG. 13 is a plan view of an output gear of a second embodiment.

FIG. 14 is a cross-sectional view taken along line XIV-XIV in FIG. 13.

FIG. 15 is a cross-sectional view of an output gear of a third embodiment.

FIG. 16 is a plan view of an output gear of a fourth embodiment.

FIG. 17 is a side view seen in a direction of an arrow XVII in FIG. 16.

FIG. 18 is a cross-sectional view taken along line XVIII-XVIII in FIG. 16.

FIG. 19 is an explanatory diagram for explaining how molten resin is filled at the time of the resin injection molding of the output gear of the fourth embodiment.

FIG. 20 is an explanatory diagram for explaining how the molten resin is filled at the time of the resin injection molding of the output gear of the fourth embodiment following a state shown in FIG. 19.

FIG. 21 is an explanatory diagram for explaining how the molten resin is filled at the time of the resin injection molding of the output gear of the fourth embodiment following a state shown in FIG. 20.

FIG. 22 is a plan view of an output gear of a fifth embodiment.

FIG. 23 is a side view seen in a direction of an arrow XXIII in FIG. 22.

FIG. 24 is a cross-sectional view taken along line XXIV-XXIV in FIG. 22.

FIG. 25 is a plan view of an output gear of a sixth embodiment.

FIG. 26 is a side view seen in a direction of an arrow XXVI in FIG. 25.

FIG. 27 is a cross-sectional view taken along line XXVII-XXVII in FIG. 25.

FIG. 28 is a plan view of an output gear of a seventh embodiment.

FIG. 29 is a cross-sectional view taken along line XXIX-XXIX in FIG. 28.

FIG. 30 is a plan view of an output gear of an eighth embodiment.

FIG. 31 is a cross-sectional view taken along line XXXI-XXXI in FIG. 30.

FIG. 32 is a cross-sectional view of an output gear and an intermediate gear of a speed reducer of a ninth embodiment.

FIG. 33 is an explanatory diagram for explaining a range in which a rib-shaped portion is formed in the output gear.

### DETAILED DESCRIPTION

Previously, there has been proposed an actuator where a torque generated by a drive device is transmitted to a driven body through a speed reducer to drive the driven body. A speed reducer of one such actuator includes a gear made of resin. In this gear, a weld-line portion, at which flows of molten resin meet at a time of resin injection molding, is formed in a toothless portion without forming the weld-line portion in a toothed portion, so that the strength of the toothed portion is increased.

However, in the above gear, although the strength of the toothed portion is high, there is a disadvantage of reducing the strength of the toothless portion since the weld-line portion is formed in the toothless portion.

According to one aspect of the present disclosure, there is provided an actuator including a speed reducer configured to output a drive force generated through rotation by a drive device after reducing a rotational speed of the rotation outputted from the drive device. The speed reducer of the actuator includes at least a gear that is formed by resin injection molding. The gear has: an insert component or a component coupling hole; a center portion; an outer peripheral portion; a connecting portion; a gate mark of the resin injection molding; a weld-line portion; and a rib-shaped portion. The insert component or the component coupling hole is located at a location that includes a rotational axis of the gear. The center portion surrounds the insert component or the component coupling hole. The outer peripheral portion is formed at an outer periphery of the gear and includes a toothed portion and a toothless portion. The connecting portion connects between the center portion and the outer peripheral portion. The gate mark is formed in at least one of the center portion, the connecting portion and the outer peripheral portion at a location which is on a radially inner side of the toothed portion. The weld-line portion is a portion where flows of molten resin meet at a time of the resin injection molding. The weld-line portion is formed in at least one of the center portion, the connecting portion and the outer peripheral portion at a location which is on a radially inner side of the toothless portion. The rib-shaped portion is formed in at least one of the center portion, the connecting portion and the outer peripheral portion at a location which includes the weld-line portion. The rib-shaped portion has a wall thickness that is larger than a wall thickness of another circumferential portion which is other than the rib-shaped portion and is located on a side of the rib-shaped portion in a circumferential direction.

According to this, in the resin gear of the speed reducer, the gate mark, which is a trace of injecting molten resin into a mold at the time of the resin injection molding, is located at the location which is on the radially inner side of the toothed portion. Thus, in the gear, since the weld-line portion is formed at the location on the radially inner side of the toothless portion and is not formed at the location on the radially inner side of the toothed portion, it is possible to maintain the strength of the toothed portion.

Furthermore, by forming the rib-shaped portion at the location, which includes the weld-line portion, a cross-sectional area of the weld-line portion is increased, and the bonding force of the resin at the time of the resin injection molding is increased. Thus, the strength of the toothless portion, which includes the weld-line portion, can be increased in the gear. Thus, this actuator can increase the strength of both of the toothed portion and the toothless portion of the gear made of the resin while the gear is provided in the speed reducer.

Furthermore, according to another aspect of the present disclosure, there is provided an actuator including a speed reducer configured to output a drive force generated through rotation by a drive device after reducing a rotational speed of the rotation outputted from the drive device. The speed reducer of the actuator includes at least a gear that is formed by resin injection molding. The gear has: an insert component or a component coupling hole; a center portion; an outer peripheral portion; a connecting portion; a gate mark of the resin injection molding; and a rib-shaped portion. The insert component or the component coupling hole is located at a location that includes a rotational axis of the gear. The center portion surrounds the insert component or the component coupling hole. The outer peripheral portion is formed at an outer periphery of the gear and includes a toothed portion and a toothless portion. The connecting portion connects between the center portion and the outer peripheral portion. The gate mark is formed in at least one of the center portion, the connecting portion and the outer peripheral portion at a location which is on a radially inner side of the toothed portion. The rib-shaped portion is formed in the center portion, the outer peripheral portion or the connecting portion at a location which includes an opposite location that is on an opposite side of the rotational axis which is opposite to the gate mark. The rib-shaped portion has a wall thickness that is larger than a wall thickness of another circumferential portion which is other than the rib-shaped portion and is located on a side of the rib-shaped portion in a circumferential direction.

According to this, in the gear formed by the resin injection molding, the weld-line portion is formed in the center portion, the outer peripheral portion or the connecting portion at the location that is on the opposite side of the rotational axis of the gear which is opposite to the gate mark. Furthermore, by forming the rib-shaped portion at the location, which includes the weld-line portion, a cross-sectional area of the weld-line portion is increased, and a bonding force of the resin at the time of the resin injection molding is increased. Thus, the strength of the toothless portion, which includes the weld-line portion, can be increased. Thus, even according to the another aspect of the present disclosure, it is possible to achieve the functions and advantages which are similar to those of the one aspect of the present disclosure.

Hereinafter, embodiments of the present disclosure will be described with reference to the drawings. In each of the following embodiments, the same or equivalent parts are designated by the same reference signs, and redundant description thereof will be omitted. In the following description, the terms upper, lower, left, and right are used for convenience of explanation, and do not limit the direction in which each member is mounted on a vehicle.

### First Embodiment

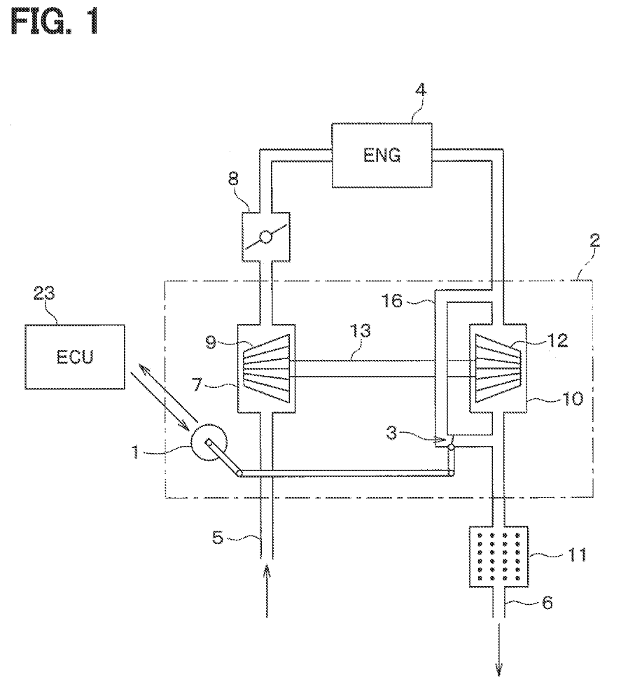

The first embodiment will be described. As shown in FIG. 1, in the first embodiment, a wastegate valve actuator for driving a wastegate valve 3, which serves as a boost pressure control valve of a supercharger 2, will be described as an actuator 1.

An engine 4 is connected to an intake air passage 5, which guides intake air into cylinders, and an exhaust passage 6, which discharges exhaust gas generated in the cylinders to the atmosphere.

An intake compressor 7 of the supercharger 2 and a throttle valve 8 are installed in the middle of the intake air passage 5 while the throttle valve 8 is for adjusting the amount of the intake air. A compressor wheel 9 of the intake compressor 7 compresses the intake air to be supplied to the engine 4. The throttle valve 8, which is located on the engine 4 side of the intake compressor 7, adjusts the amount of the intake air supplied into the cylinders of the engine 4 according to the amount of depression of an accelerator pedal (not shown).

An exhaust turbine 10 of the supercharger 2 and a catalyst 11 are installed in the middle of the exhaust passage 6 while the catalyst 11 is for purifying the exhaust gas. A turbine wheel 12 of the exhaust turbine 10 is connected to the compressor wheel 9 through a shaft 13. Specifically, in the supercharger 2, the turbine wheel 12 is rotated by the exhaust gas energy of the engine 4, and a torque of the turbine wheel 12 is conducted to the compressor wheel 9 through the shaft 13 to rotate the compressor wheel 9. The catalyst 11, which is located on the downstream side of the exhaust turbine 10 of the supercharger 2, is a well-known three-way catalyst that has a monolith structure. The catalyst 11 purifies harmful substances contained in the exhaust gas by an oxidizing action and a reducing action when the catalyst 11 is heated to an activation temperature thereof by the exhaust gas.

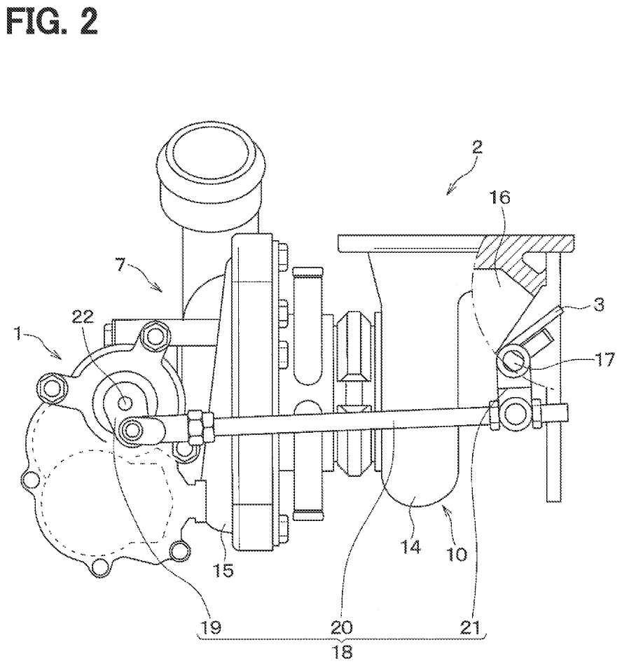

As shown in FIGS. 1 and 2, the supercharger 2 includes the exhaust turbine 10, the intake compressor 7 and the actuator 1. The exhaust turbine 10 includes: the turbine wheel 12, which is rotated by the exhaust gas discharged from the engine 4; and a turbine housing 14, which is shaped in a spiral form and receives the turbine wheel 12. The intake compressor 7 includes the compressor wheel 9, which is rotated by a rotational force of the turbine wheel 12, and a compressor housing 15, which is shaped in a spiral form and receives the compressor wheel 9. The turbine wheel 12 is connected to the compressor wheel 9 through the shaft 13.

Besides the turbine wheel 12, a bypass passage 16 is provided in the turbine housing 14. The bypass passage 16 is a passage that directly guides the exhaust gas, which flows into the turbine housing 14, into an exhaust gas outlet of the turbine housing 14 by bypassing the turbine wheel 12 without supplying the exhaust gas to the turbine wheel 12. The bypass passage 16 is formed in parallel with the turbine wheel 12.

The bypass passage 16 is opened and closed by the wastegate valve 3, which serves as the boost pressure control valve. The wastegate valve 3 is rotatably supported by a valve shaft 17 at an inside of the turbine housing 14. When the wastegate valve 3 is opened, a portion of the exhaust gas discharged from the engine 4 is directly guided to the catalyst 11 through the bypass passage 16. The wastegate valve 3 is opened when the pressure of the exhaust gas discharged from the engine 4 is increased beyond a valve opening pressure of the wastegate valve 3. The wastegate valve 3 is also driven by the actuator 1 to open and close the wastegate valve 3. Specifically, the actuator 1 opens and closes the wastegate valve 3 through a link mechanism 18 located between the actuator 1 and the wastegate valve 3. The wastegate valve 3 is an example of a driven body located at an outside of the actuator.

The actuator 1 is installed to the intake compressor 7 that is placed at a location remote from the exhaust turbine 10 of the supercharger 2. This makes it possible to avoid the influence of the heat of the exhaust gas on the actuator 1. The output of the actuator 1 is transmitted to the wastegate valve 3 through the link mechanism 18. In the present embodiment, as the link mechanism 18, there is used a four-bar linkage mechanism that includes an actuator lever 19, a rod 20, and a valve lever 21. The actuator lever 19 is connected to an output shaft 22 of the actuator 1 and is rotated by the actuator 1. The rod 20 is connected to the actuator lever 19 and the valve lever 21. The valve lever 21 is coupled to the valve shaft 17 to rotate the valve shaft 17.

An electronic control unit (ECU) 23, which has a microcomputer, controls the operation of the actuator 1. Specifically, the ECU 23 controls the actuator 1 such that an opening degree of the wastegate valve 3 is adjusted through the actuator 1 at the time of rotating the engine 4 at a high rotational speed to control a boost pressure of the supercharger 2. Furthermore, the ECU 23 controls the actuator 1 such that the wastegate valve 3 is fully opened when the temperature of the catalyst 11 does not reach the activation temperature, for example, immediately after a cold start. As a result, the high-temperature exhaust gas, from which the heat is not taken by the turbine wheel 12, can be directly guided to the catalyst 11 to warm up the catalyst 11 within a short time.

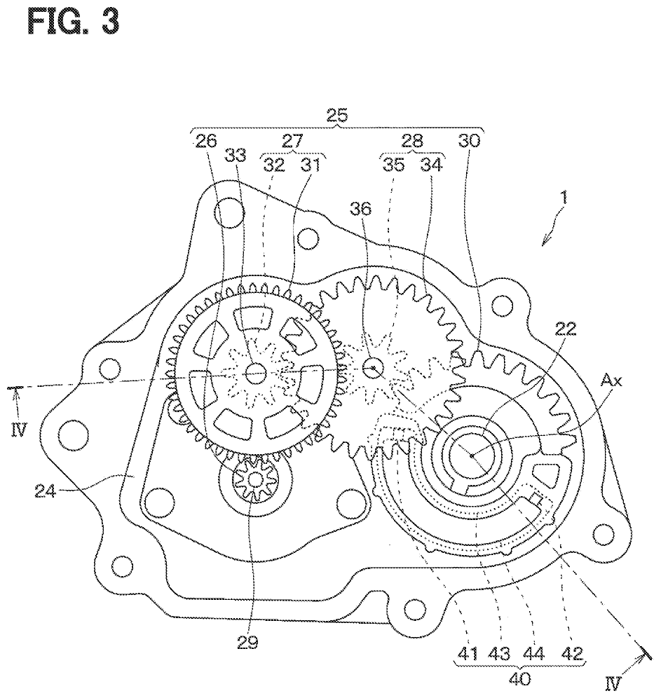

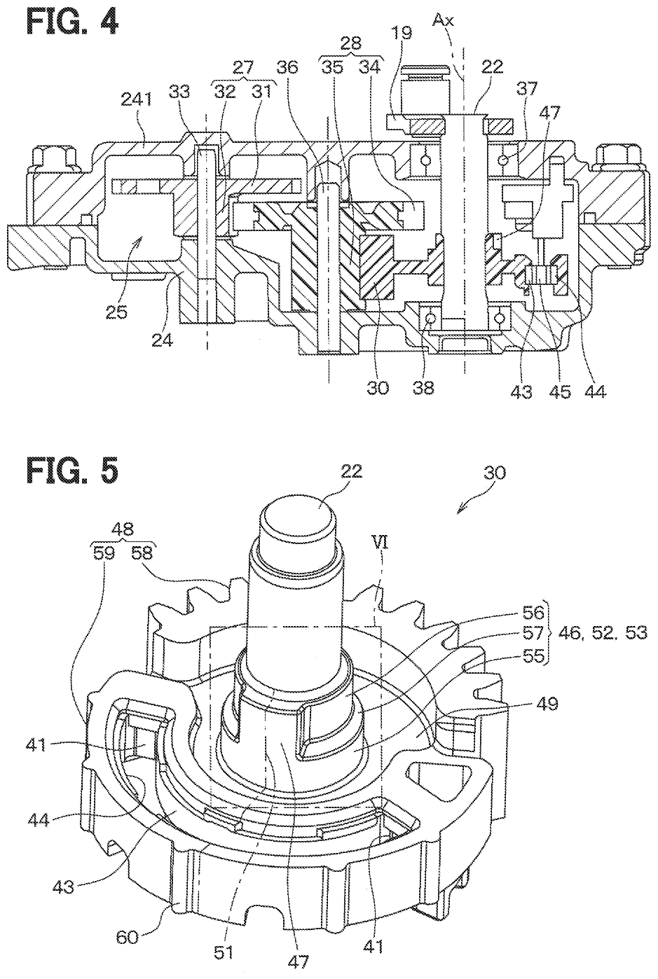

Next, the actuator 1 will be described with reference to FIGS. 3 and 4. The actuator 1 includes a speed reducer 25 which is received in a housing 24 and a housing cover 241. The speed reducer 25 outputs a drive force generated through rotation by an undepicted electric motor (serving as a drive device) through the output shaft 22 after reducing a rotational speed of the rotation outputted from the electric motor. The speed reducer 25 is a parallel shaft gear speed reducer that includes a plurality of gears. In the present embodiment, the speed reducer 25 includes a pinion gear 26, a first intermediate gear 27, a second intermediate gear 28 and an output gear 30 as the plurality of gears.

The pinion gear 26 is fixed to a motor shaft 29 of the undepicted electric motor. The first intermediate gear 27 is a two-stage gear that includes a first large gear 31 and a first small gear 32 formed together in one-piece while a diameter of the first small gear 32 is smaller than a diameter of the first large gear 31. The two-stage gear is also referred to as a composite gear. The first intermediate gear 27 is rotatably supported by a first shaft 33 and rotates about the first shaft 33. The first large gear 31 is meshed with the pinion gear 26 that is fixed to the motor shaft 29.

The second intermediate gear 28 is also a two-stage gear that includes a second large gear 34 and a second small gear 35 formed together in one-piece while a diameter of the second small gear 35 is smaller than a diameter of the second large gear 34. The second intermediate gear 28 is rotatably supported by a second shaft 36 and rotates about the second shaft 36. The second large gear 34 is meshed with the first small gear 32 of the first intermediate gear 27.

The output gear 30 is meshed with the second small gear 35. The output gear 30 of the present embodiment is a resin gear formed by resin injection molding. Therefore, the output gear 30 serves at least a gear formed by the resin injection molding. The output gear 30 is fixed to the output shaft 22. The output shaft 22 is rotatably supported by two bearings 37, 38 which are respectively installed to the housing 24 and the housing cover 241. One end portion of the output shaft 22 extends to an outside from the housing cover 241. The actuator lever 19 of the link mechanism 18 is fixed to the one end portion of the output shaft 22.

A magnetic circuit device 40 is installed to the output gear 30. The magnetic circuit device 40 includes two magnets (serving as magnetic flux generating portions) 41, 42 and two yokes (serving as magnetic flux transmitting portions) 43, 44. The magnets 41, 42 and the yokes 43, 44 form a closed magnetic circuit which is shaped in an arcuate form in a view taken in the axial direction of the output shaft 22. The magnetic circuit device 40 is rotated integrally with the output gear 30 and the output shaft 22.

A magnetic flux sensing device 45, which senses the magnetic flux of the magnets 41, 42, is placed at an inside of the closed magnetic circuit of the magnetic circuit device 40 of the output gear 30. The magnetic flux sensing device 45 is formed by, for example, a Hall IC. The magnetic circuit device 40 and the magnetic flux sensing device 45 function as a rotational angle sensor that senses a rotational angle of the output shaft 22. The basic uses and functions of the magnetic circuit device 40 and the magnetic flux sensing device 45 are the same as those disclosed in JP2014-126548A (corresponding to US2014/0184204A, the entire disclosure of which is incorporated herein by reference). The rotational angle of the output shaft 22, which is sensed by the magnetic flux sensing device 45, is outputted to the ECU 23. The structures of the magnetic circuit device 40 and the magnetic flux sensing device 45 described above are examples, and the magnetic circuit device 40 and the magnetic flux sensing device 45 may be configured to have other structures.

Hereinafter, the output gear 30 will be described in detail.

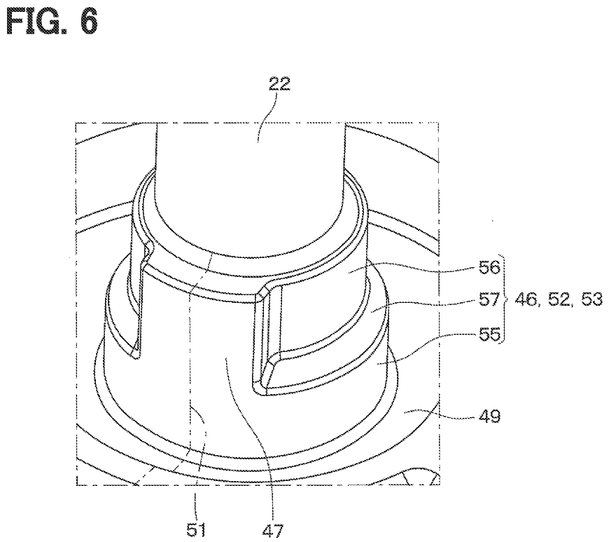

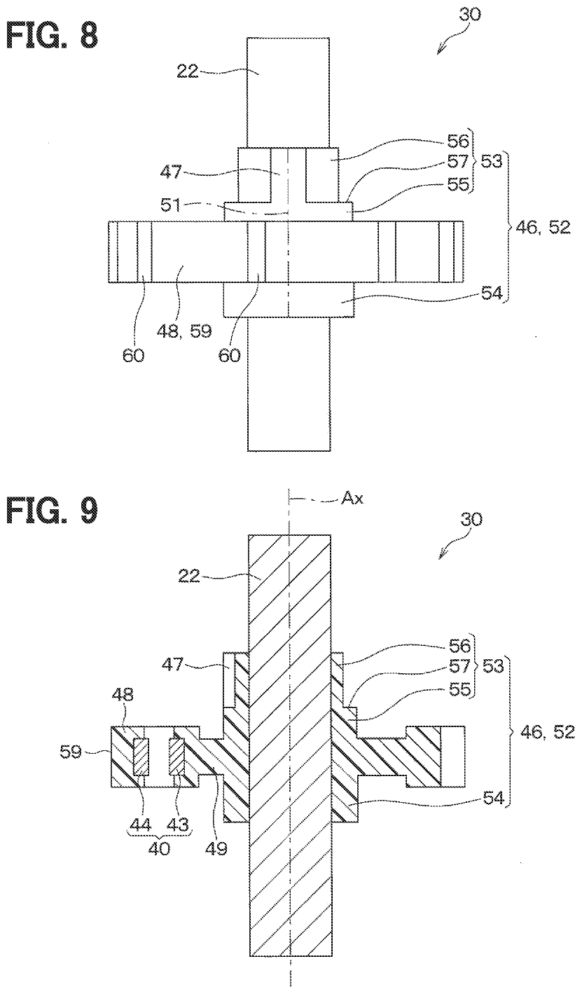

As shown in FIGS. 5 to 9, the output gear 30 includes the output shaft 22, a center portion 46, a rib-shaped portion 47, an outer peripheral portion 48, a connecting portion 49, a gate mark 50 and a weld-line portion 51. The output shaft 22 is made of, for example, metal. In contrast, the center portion 46, the rib-shaped portion 47, the outer peripheral portion 48, the connecting portion 49, the gate mark 50 and the weld-line portion 51 are made of resin. In the following description, the portion of the output gear 30, which is made of the resin, may also be referred to as a resin portion.

The output shaft 22 is located at a location where the rotational axis Ax of the output gear 30 is placed. In the following description, the rotational axis Ax of the output gear 30 will be simply referred to as an axis Ax, and an axial direction of the axis Ax will be simply referred to as an axial direction. The output shaft 22 is an insert component that is placed in a mold and is insert molded together with the resin portion in the output gear 30 at the time of the resin injection molding of the output gear 30. The output shaft 22 is a member that is configured to transmit the torque to the driven body located at the outside of the actuator 1. As described above, the output shaft 22 transmits the torque from the one end portion of the output shaft 22 to the wastegate valve (serving as the driven body) 3 located at the outside through the link mechanism 18.

The center portion 46 of the resin portion of the output gear 30 is formed to surround the periphery of the output shaft 22. A shaft holding portion 52 is formed in the center portion 46 such that the shaft holding portion 52 projects on one side and the other side of the connecting portion 49 in the axial direction and holds the output shaft 22. A portion of the shaft holding portion 52, which projects on the one side (i.e., the side where the link mechanism 18 is placed) of the connecting portion 49 in the axial direction, will be referred to as a first shaft holding portion 53, and another portion of the shaft holding portion 52, which projects on the other side of the connecting portion 49 in the axial direction, will be referred to as a second shaft holding portion 54. A length of the first shaft holding portion 53, which is measured in the axial direction, is longer than a length of the second shaft holding portion 54, which is measured in the axial direction.

In the present embodiment, the first shaft holding portion 53 includes: a large-diameter portion 55 that is located at a side of the first shaft holding portion 53 where the connecting portion 49 is placed; a small-diameter portion 56 that has a diameter smaller than a diameter of the large-diameter portion 55 and is located on the opposite side of the large-diameter portion 55 which is opposite to the connecting portion 49; and a stepped portion 57 that is formed between the large-diameter portion 55 and the small-diameter portion 56 to connect therebetween. Therefore, the first shaft holding portion 53 is formed such that a cross-sectional area of the small-diameter portion 56, which is perpendicular to the axis Ax, is smaller than a cross-sectional area of the large-diameter portion 55, which is perpendicular to the axis Ax. Specifically, the first shaft holding portion 53 is formed such that a cross-sectional area of a remote portion of the first shaft holding portion 53, which is remote from the connecting portion 49, is smaller than a cross-sectional area of an adjacent portion of the first shaft holding portion 53, which is adjacent to the connecting portion 49, while the cross-sectional area of the remote portion and the cross-sectional area of the adjacent portion are perpendicular to the axis Ax.

The rib-shaped portion 47 is formed in the first shaft holding portion 53. The rib-shaped portion 47 is a portion that has a wall thickness larger than a wall thickness of another circumferential portion (or a remaining circumferential portion) which is other than the rib-shaped portion 47 and is located on a side of the rib-shaped portion 47 in a circumferential direction. The rib-shaped portion 47 is formed at the small-diameter portion 56 of the first shaft holding portion 53. The rib-shaped portion 47 has a predetermined width in the circumferential direction and radially outwardly projects from the small-diameter portion 56. Therefore, the rib-shaped portion 47 has the wall thickness which is measured in the radial direction and is larger than a wall thickness of the small-diameter portion 56 measured in the radial direction. A radially outer surface of the rib-shaped portion 47 and a radially outer surface of the large-diameter portion 55 form a continuous surface, i.e., are continuous with each other without forming a step therebetween.

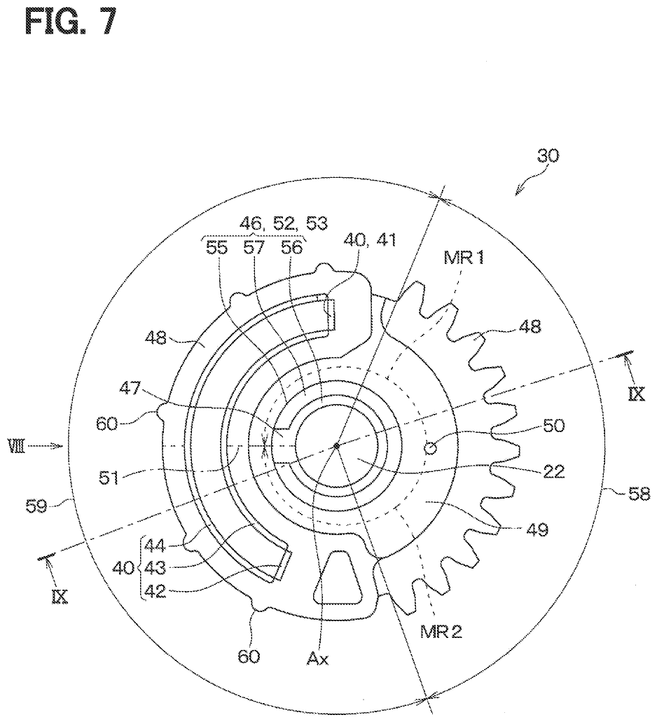

The outer peripheral portion 48 of the resin portion of the output gear 30 includes a toothed portion 58 and a toothless portion 59 at the outer periphery of the output gear 30. In FIG. 7, a range of the toothed portion 58 and a range of the toothless portion 59 in the outer peripheral portion 48 are indicated by two double-sided arrows, respectively. The toothed portion 58 is a portion that has a plurality of teeth and is located at the outer periphery of the output gear 30. The teeth of the toothed portion 58 are configured to mesh with the second small gear 35 of the second intermediate gear 28. In contrast, the toothless portion 59 is a portion that has no tooth and is located at the outer periphery of the output gear 30. The magnetic circuit device 40 described above is located at a radially inner side part of the toothless portion 59. The magnetic circuit device 40 includes the two magnets (serving as magnetic flux generating portions) 41, 42 and the two yokes (serving as magnetic flux transmitting portions) 43, 44.

The outer peripheral portion 48 has a plurality of projections 60 that radially outwardly project from the toothless portion 59. Each of the projections 60 is used as a portion, against which a corresponding one of a plurality of ejector pins contacts at the time of pushing out the output gear 30 from a space (hereinafter, referred to as a cavity) of the mold during the resin injection molding of the output gear 30. With this configuration, it is possible to reduce a force applied from the ejector pins to the magnetic circuit device 40.

The connecting portion 49 of the resin portion of the output gear 30 is a portion that connects between the center portion 46 and the outer peripheral portion 48. A thickness of the connecting portion 49 measured in the axial direction is smaller than a thickness of the center portion 46 measured in the axial direction and is smaller than a thickness of the outer peripheral portion 48 measured in the axial direction.

The gate mark 50 is formed in the connecting portion 49 at a location that is on the radially inner side of the toothed portion 58. The gate mark 50 is a trace of an inlet (i.e., a gate of the mold) through which the molten resin is injected into the space inside the mold at the time of the resin injection molding. The gate mark 50 is formed in the resin portion at only one location on the radially inner side of the toothed portion 58. Specifically, the gate mark 50 is formed on or near an imaginary line that connects a center of the toothed portion 58 and the axis Ax of the gear in the resin portion.

As indicated by two broken line arrows MR1, MR2 in FIG. 7, the molten resin, which is injected into the cavity from the gate of the mold, form two flows of the molten resin that flow while bypassing the output shaft 22 placed in the cavity at the time of the resin injection molding. These flows of the molten resin meet at a predetermined location on the radially inner side of the toothless portion 59 (more specifically on the radially inner side of the radially outer periphery of the toothless portion 59) in the resin portion. Therefore, a weld-line portion 51 is formed as a portion where the flows of the molten resin meet at the time of the resin injection molding, and the weld-line portion 51 is formed in the center portion 46, the connecting portion 49 and the outer peripheral portion 48 at a predetermined location which is on the radially inner side of the toothless portion 59. In FIGS. 5 to 8, the location, at which the weld-line portion 51 is formed in the output gear 30, is indicated by a dot-dash line. Needless to say, the shape of the weld-line portion 51 and the like change depending on the state of the molten resin and the like.

In the present embodiment, the volume of the resin portion on the left and right sides of an imaginary plane, which includes the axis Ax of the output gear 30 and the gate mark 50, and the flow path resistance inside the mold on the left and right sides of the imaginary plane, are set to form the weld-line portion 51 on an opposite side of the axis Ax which is opposite to the gate mark 50. Therefore, the gate mark 50 and the weld-line portion 51 are provided at two positions, respectively, which are substantially symmetrical with respect to the axis Ax. The rib-shaped portion 47 described above is provided at the location that includes the weld-line portion 51. Specifically, the shape of the resin portion of the output gear 30 is designed such that the weld-line portion 51 is formed in the rib-shaped portion 47. As described above, in the present embodiment, the rib-shaped portion 47 is formed in the center portion 46 at the location that includes the weld-line portion 51. In addition to the center portion 46, the rib-shaped portion 47 may be formed in the connecting portion 49 and the outer peripheral portion 48 at the location that includes the weld-line portion 51.

Furthermore, it can be said that the rib-shaped portion 47 is formed in the center portion 46 at the location that is on the opposite side of the axis Ax which is opposite to the gate mark 50. This is because the weld-line portion 51 is formed in the center portion 46 at the location that is on the opposite side of the axis Ax which is opposite to the gate mark 50, so that this is the location at which the rib-shaped portion 47 and the weld-line portion 51 overlap with each other. In addition to the center portion 46, the rib-shaped portion 47 may be formed in the connecting portion 49 and the outer peripheral portion 48 at the location that is on the opposite side of the axis Ax which is opposite to the gate mark 50.

Next, the flows of the molten resin at the time of the resin injection molding of the output gear 30 will be described.

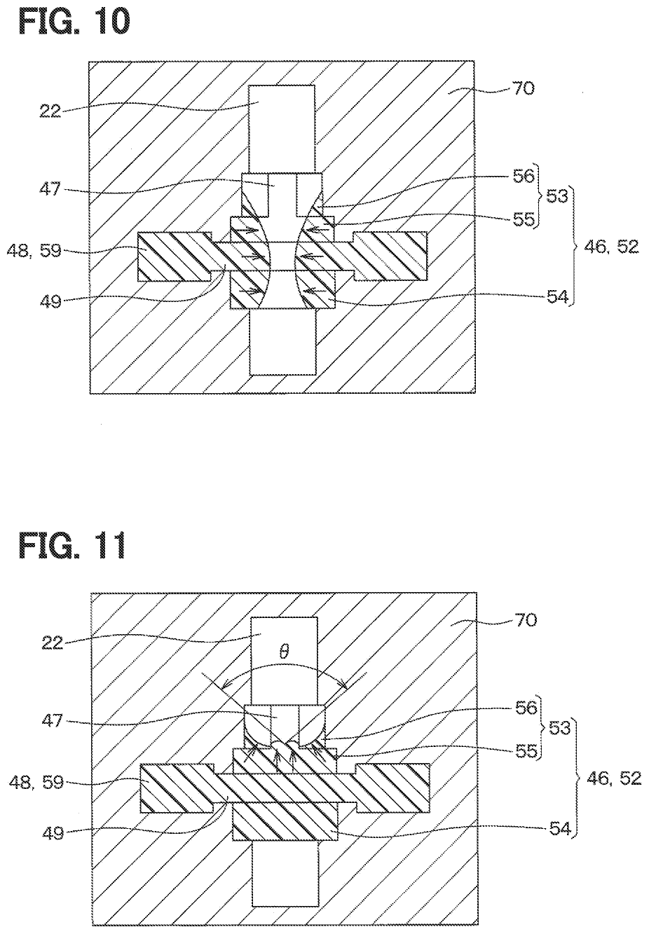

FIGS. 10 to 12 are explanatory diagrams for explaining how the molten resin is filled particularly in the center portion 46 and the rib-shaped portion 47 at the time of the resin injection molding of the output gear 30. In FIGS. 10 to 12, an inner wall of a cavity of a mold 70 and the output shaft 22 are indicated by solid lines. Furthermore, in FIGS. 10 to 12, in order to show the molten resin filled in the cavity of the mold 70 in an easy-to-understand manner, the molten resin is indicated with a resin hatching pattern although it is not a cross-section.

As shown in FIG. 10, at the time of the resin injection molding of the output gear 30, the molten resin, which is injected into the cavity from the gate (not shown) of the mold 70, flows from the toothed portion 58 side, at which the gate is placed, toward the toothless portion 59 side of the resin portion while bypassing the output shaft 22. Then, as shown by arrows in FIG. 10, the left molten resin flow and the right molten resin flow, which are conducted to the toothless portion 59 side while bypassing the output shaft 22, gradually approach each other. At this time, the molten resin is quickly filled in large volume portions of the cavity of the mold 70, each of which has a relatively large volume, and the molten resin is later filled in small volume portions of the cavity of the mold 70, each of which has a relatively small volume.

Next, as shown in FIG. 11, the left molten resin flow and the right molten resin flow, which are conducted to the toothless portion 59 side, meet at the large-diameter portion 55 of the center portion 46, the connecting portion 49 and the outer peripheral portion 48. Then, the molten resin is mainly filled from the large-diameter portion 55 into the rib-shaped portion 47 which has a larger volume in comparison to the small-diameter portion 56. As indicated by arrows in FIG. 11, in the rib-shaped portion 47, the molten resin is progressively filled from the large-diameter portion 55 side toward a distal end side of the rib-shaped portion 47. At that time, a meeting angle θ of the left and right flows of the molten resin, which meet at the rib-shaped portion 47, becomes a relatively large angle.

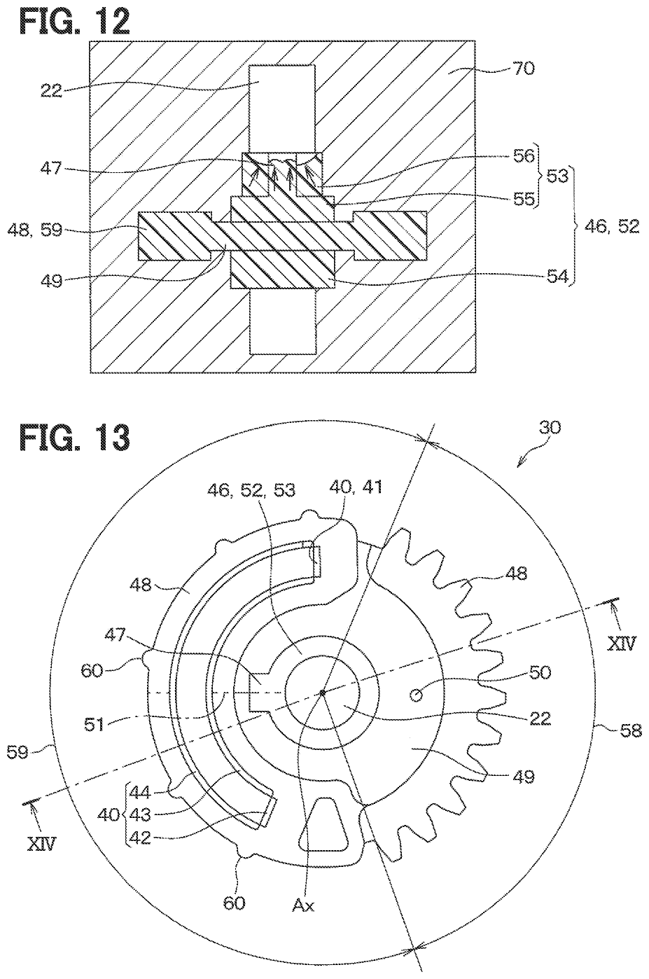

Subsequently, as shown in FIG. 12, the merged molten resin flow, which is merged at the rib-shaped portion 47, is progressively filled into the distal end portion (i.e., in a direction away from the large-diameter portion 55) at the earlier time than the time of filling the molten resin into the small-diameter portion 56 or almost at the same time as the time of filling the molten resin into the small-diameter portion 56. After the time of fully filling the molten resin into the rib-shaped portion 47 or almost at the same time as the time of fully filling the molten resin into the rib-shaped portion 47, the molten resin is fully filled into the small-diameter portion 56 located on the left and right sides of the rib-shaped portion 47. Therefore, the left and right flows of the molten resin are reliably joined at the weld-line portion 51 formed at the rib-shaped portion 47. Then, after the molten resin is cooled and solidified in the mold 70, the mold 70 is opened, and the output gear 30 is taken out from the mold 70.

The actuator 1 of the first embodiment described above provides the following functions and advantages.

(1) In the first embodiment, the speed reducer 25 of the actuator 1 includes the output gear 30 made of the resin. In the output gear 30, the gate mark 50 of the resin injection molding is formed at the location which is on the radially inner side of the toothed portion 58, and the weld-line portion 51 is formed at the location which is on the radially inner side of the toothless portion 59. The rib-shaped portion 47 is formed in the center portion 46 of the output gear 30 at the location that includes the weld-line portion 51.

According to this configuration, in the output gear 30, since the weld-line portion 51 is not formed at the location which is on the radially inner side of the toothed portion 58, it is possible to maintain the strength of the toothed portion 58.

Furthermore, in the output gear 30, the rib-shaped portion 47 is formed at the location which is on the radially inner side of the toothless portion 59 and includes the weld-line portion 51, so that the cross-sectional area of the weld-line portion 51 is increased, and a bonding force of the resin is increased at the time of the resin injection molding. Therefore, it is possible to increase the strength of the toothless portion 59 that includes the weld-line portion 51. Thus, this actuator 1 can increase the strength of both of the toothed portion 58 and the toothless portion 59 of the output gear 30 made of the resin while the output gear 30 is provided in the speed reducer 25.

(2) In the first embodiment, the shaft holding portion 52 is formed in the center portion 46 such that the shaft holding portion 52 projects on the one side or the other side of the connecting portion 49 in the axial direction and holds the output shaft 22. According to this configuration, a torsional torque resulting in a high stress is applied to the output gear 30 of the speed reducer 25 of the actuator 1 through the link mechanism 18 from the wastegate valve 3, which is placed under the environment where pulsations of the exhaust gas are generated. On the other hand, since the output gear 30 has the shaft holding portion 52 formed in the center portion 46, it is possible to increase the strength against the torsional torque generated between the output shaft 22 and the toothed portion 58.

(3) In the first embodiment, the length of the first shaft holding portion 53 is longer than the length of the second shaft holding portion 54. According to this, the torsional torque, which is generated between the output shaft 22 and the toothed portion 58, acts more largely on the first shaft holding portion 53 than the second shaft holding portion 54. By increasing the length of the first shaft holding portion 53, the strength of the first shaft holding portion 53 can be increased.

(4) In the first embodiment, the rib-shaped portion 47 is formed at the first shaft holding portion 53. According to this configuration, even when the first shaft holding portion 53 becomes the final filling portion of the molten resin at the time of the resin injection molding, the strength of the weld-line portion 51 formed at the first shaft holding portion 53 can be increased by the rib-shaped portion 47.

(5) In the first embodiment, the shaft holding portion 52 is formed such that the cross-sectional area of the remote portion (e.g., the small-diameter portion 56) of the shaft holding portion 52, which is remote from the connecting portion 49, is smaller than the cross-sectional area of the adjacent portion (e.g., the large-diameter portion 55) of the shaft holding portion 52, which is adjacent to the connecting portion 49, while the cross-sectional area of the remote portion and the cross-sectional area of the adjacent portion are perpendicular to the axis Ax. The rib-shaped portion 47 is formed at the remote portion (e.g., the small-diameter portion 56) which is remote from the connecting portion 49.

Generally, in the resin injection molding, the molten resin is filled in the portion having the large cross-sectional area in the mold at the early stage, and the molten resin is filled in the portion having the small cross-sectional area in the mold later. Therefore, during the resin injection molding, in the shaft holding portion 52, the molten resin is filled from the adjacent portion (e.g., the large-diameter portion 55) to the rib-shaped portion 47 in the mold at the early stage, and the molten resin is filled in the remote portion (e.g., the small-diameter portion 56), which is remote from the connecting portion 49 and has the small cross-sectional area in the mold later. Thus, the meeting angle of the flows of the molten resin, which is filled in the rib-shaped portion 47, becomes large at an end part of the rib-shaped portion 47 which is opposite to the connecting portion 49, so that the strength of the weld-line portion 51 formed at the rib-shaped portion 47 can be increased.

(6) In the first embodiment, the rib-shaped portion 47 is formed such that the rib-shaped portion 47 radially outwardly projects from the small-diameter portion 56 of the first shaft holding portion 53.

With this configuration, by making the cross-sectional area of the rib-shaped portion 47 larger than the cross-sectional area of the small-diameter portion 56, the molten resin is filled into the rib-shaped portion 47 at the early stage during the resin injection molding. Therefore, the meeting angle of the flows of the molten resin, which is filled into the rib-shaped portion 47, becomes large at the end part of the rib-shaped portion 47 which is opposite to the connecting portion 49, so that the strength of the weld-line portion 51 formed at the rib-shaped portion 47 can be increased.

(7) In the first embodiment, the radially outer surface of the rib-shaped portion 47, which is formed at the small-diameter portion 56 of the first shaft holding portion 53, is continuous with the radially outer surface of the large-diameter portion 55 of the first shaft holding portion 53. With this configuration, the output gear 30 can be made into a simple shape.

(8) In the first embodiment, only one gate mark 50 is formed in the connecting portion 49 at the location that is on the radially inner side of the toothed portion 58. If there are a plurality of gates at the time of the resin injection molding, the weld-line portion 51 is also formed between each adjacent two of the plurality of gates. In contrast, by providing only the one gate mark 50, the output gear 30 of the first embodiment can form the weld-line portion 51 at the intended location which is on the radially inner side of the toothless portion 59.

(9) In the first embodiment, the output gear 30 has the magnetic circuit device 40 installed at the toothless portion 59. With this configuration, since the strength of the toothless portion 59 is increased by the rib-shaped portion 47, the magnetic circuit device 40 can be reliably held at the toothless portion 59. Therefore, the reliability of sensing the position of the output gear 30 using the magnetic circuit device 40 can be improved.

(10) In the first embodiment, the output gear 30 has the gate mark 50 of the resin injection molding formed at the location that is on the radially inner side of the toothed portion 58. The rib-shaped portion 47 is formed at the location that is on the opposite side of the axis Ax of the output gear 30 which is opposite to the gate mark 50. Therefore, in the output gear 30, the weld-line portion 51 is formed at the location that is on the opposite side of the axis Ax of the output gear 30 which is opposite to the gate mark 50. In the output gear 30, by forming the rib-shaped portion 47 at the location, which includes the weld-line portion 51, the cross-sectional area of the weld-line portion 51 is increased, and the bonding force of the resin at the time of the resin injection molding is increased. Thus, the strength of the toothless portion 59, which includes the weld-line portion 51, can be increased.

(11) In the first embodiment, the actuator 1 is configured to drive the wastegate valve 3 which serves as the boost pressure control valve of the supercharger 2.

According to this configuration, the torsion torque resulting in the high stress is applied to the output gear 30 of the speed reducer 25 of the actuator 1 from the wastegate valve 3, which is placed under the environment where pulsations of the exhaust gas are generated. However, in the actuator 1, the strength of both the toothed portion 58 and the toothless portion 59 in the output gear 30 is high, so that it is possible to maintain the high reliability against the torsion torque resulting in the high stress.

### Second to Eighth Embodiments

The second to eighth embodiments will be described. Each of the second to eighth embodiments is a modification of the first embodiment, in which the structure of the output gear 30 is partially modified, and the rest of the structure of each of the second to eighth embodiments is the same as that of the first embodiment. Therefore, in each of the second to eighth embodiments, only different portions, which are different from those of the first embodiment, will be described.

### Second Embodiment

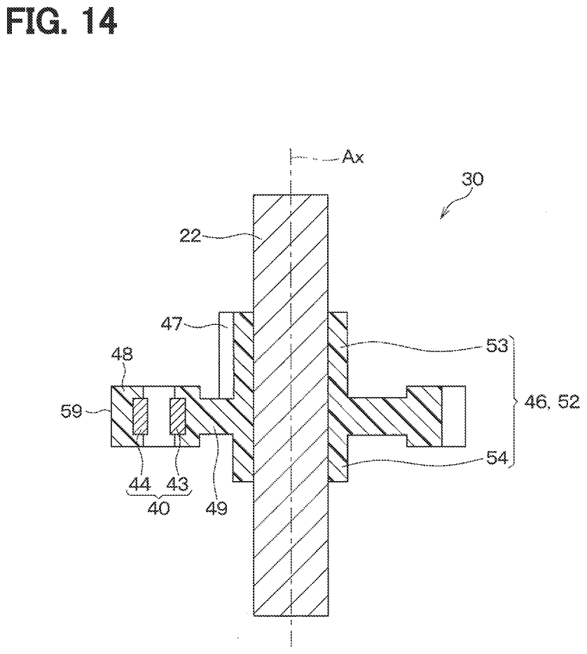

As shown in FIGS. 13 and 14, in the second embodiment, the first shaft holding portion 53, which is formed in the center portion 46 of the output gear 30, has a generally constant cross-sectional area, which is perpendicular to the axis Ax and is generally constant from an upper end part of the first shaft holding portion 53 to the connecting portion 49 in the axial direction. The rib-shaped portion 47 is formed in the first shaft holding portion 53 at the location which includes the weld-line portion 51. In other words, the rib-shaped portion 47 is formed in the first shaft holding portion 53 at the location that is on the opposite side of the axis Ax of the output gear 30 which is opposite to the gate mark 50 located on the radially inner side of the toothed portion 58. The rib-shaped portion 47 extends from the upper end part of the first shaft holding portion 53 to the connecting portion 49 in the axial direction. The rib-shaped portion 47 has a predetermined width in the circumferential direction and radially outwardly projects from the first shaft holding portion 53. Therefore, the rib-shaped portion 47 has the wall thickness which is measured in the radial direction and is larger than the wall thickness of the first shaft holding portion 53 measured in the radial direction.

Even in the structure of the second embodiment, since the cross-sectional area of the rib-shaped portion 47 is larger than the cross-sectional area of the first shaft holding portion 53, the meeting angle of the flows of the molten resin, which meet at the rib-shaped portion 47, becomes a relatively large angle at the time of the resin injection molding of the output gear 30. Therefore, the flows of the molten resin are reliably joined at the weld-line portion 51 formed at the rib-shaped portion 47. Thus, the second embodiment described above can also achieve the functions and advantages which are similar to those of the first embodiment.

### Third Embodiment

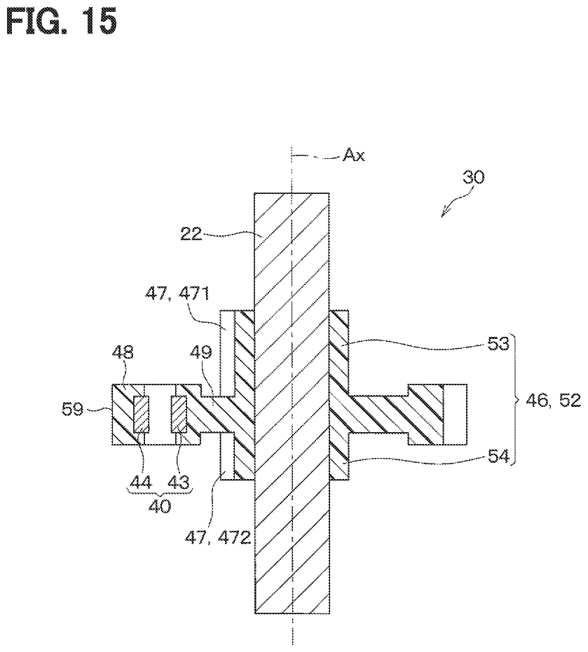

As shown in FIG. 15, even in the third embodiment, the first shaft holding portion 53 has the generally constant cross-sectional area which is perpendicular to the axis Ax and is generally constant from the upper end part of the first shaft holding portion 53 to the connecting portion 49 in the axial direction. Furthermore, the second shaft holding portion 54 also has a generally constant cross-sectional area which is perpendicular to the axis Ax and is generally constant from a lower end part of the second shaft holding portion 54 to the connecting portion 49 in the axial direction.

In the third embodiment, the rib-shaped portion 47 is formed in the first shaft holding portion 53 at the location that includes the weld-line portion 51, and the rib-shaped portion 47 is also formed in the second shaft holding portion 54 at the location which includes the weld-line portion 51. In other words, the rib-shaped portion 47 is formed in each of the first shaft holding portion 53 and the second shaft holding portion 54 at the location that is on the opposite side of the axis Ax of the output gear 30 which is opposite to the gate mark 50 located on the radially inner side of the toothed portion 58.

In the description of the third embodiment, the rib-shaped portion 47, which is formed in the first shaft holding portion 53, will be referred to as an upper rib-shaped portion 471, and the rib-shaped portion 47, which is formed in the second shaft holding portion 54, will be referred to as a lower rib-shaped portion 472. The upper rib-shaped portion 471 extends from the upper end part of the first shaft holding portion 53 to the connecting portion 49 in the axial direction. The lower rib-shaped portion 472 extends from the lower end part of the second shaft holding portion 54 to the connecting portion 49 in the axial direction. Each of the upper rib-shaped portion 471 and the lower rib-shaped portion 472 has a predetermined width in the circumferential direction and radially outwardly projects from the corresponding one of the first shaft holding portion 53 and the second shaft holding portion 54. Therefore, each of the upper rib-shaped portion 471 and the lower rib-shaped portion 472 has a wall thickness which is measured in the radial direction and is larger than a wall thickness of the corresponding one of the first shaft holding portion 53 and the second shaft holding portion 54 measured in the radial direction.

The third embodiment described above can also achieve the functions and advantages which are similar to those of the first embodiment.

Furthermore, in the structure of the third embodiment, the first shaft holding portion 53 and the second shaft holding portion 54 may possibly become a last filling portion of the molten resin which is filled last during the resin injection molding. In such a case, the strength of the weld-line portion 51, which is formed in the first shaft holding portion 53 and the second shaft holding portion 54, can be increased by the upper rib-shaped portion 471 and the lower rib-shaped portion 472. Therefore, the strength of the toothless portion 59 of the output gear 30 can be increased.

In a modification of the third embodiment described above, the output gear 30 may be formed such that the upper rib-shaped portion 471 is not formed in the first shaft holding portion 53, and the lower rib-shaped portion 472 is formed only in the second shaft holding portion 54.

### Fourth Embodiment

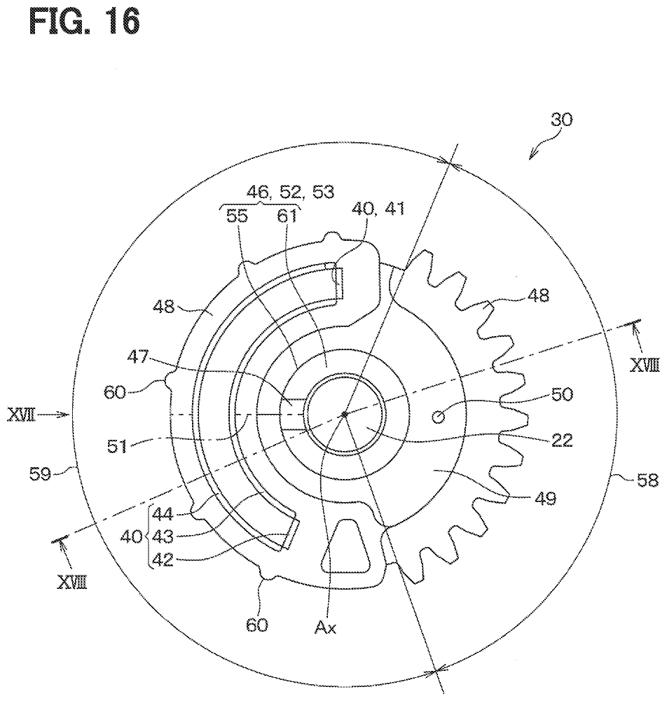

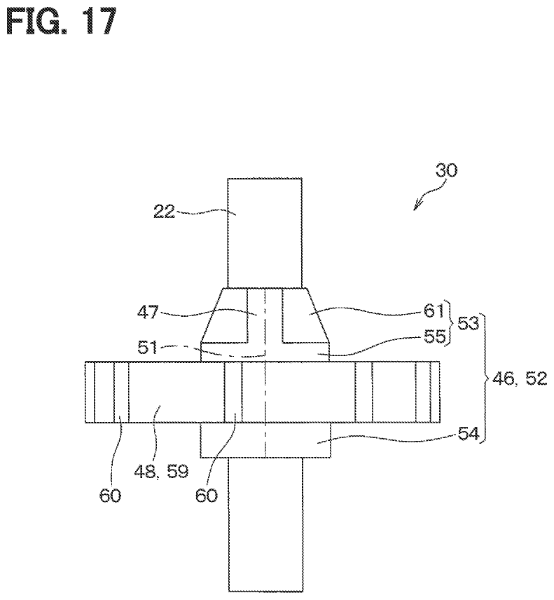

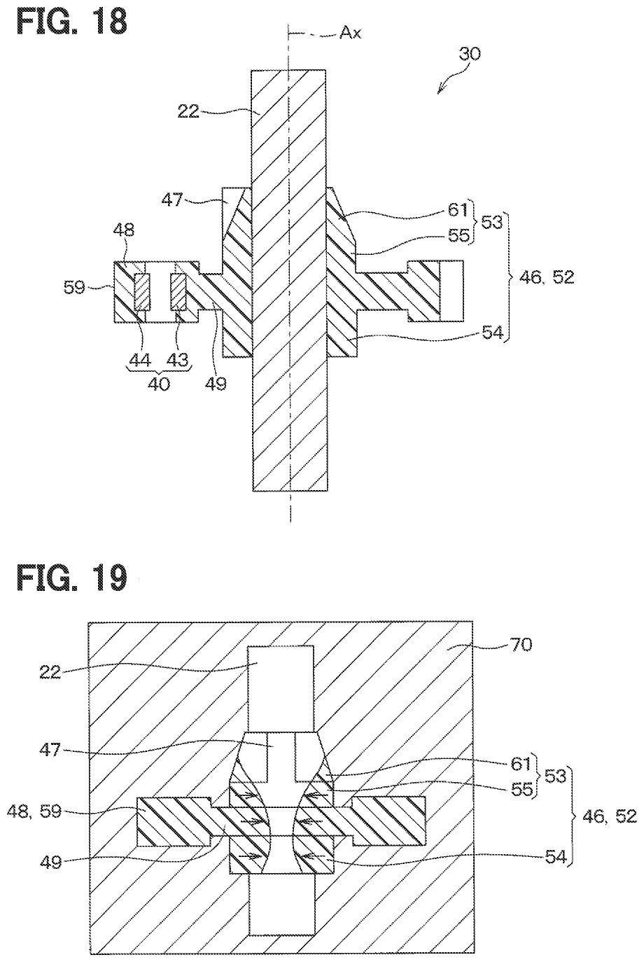

As shown in FIGS. 16 to 18, in the fourth embodiment, in the output gear 30, the first shaft holding portion 53, which is formed in the center portion 46, has the large-diameter portion 55, which is formed at the connecting portion 49 side of the first shaft holding portion 53, and a tapered portion 61, which is formed at an opposite side of the first shaft holding portion 53 that is opposite to the connecting portion 49 with respect to the large-diameter portion 55. The tapered portion 61 has a cross-sectional area which is perpendicular to the axis Ax and is progressively reduced in a direction away from the connecting portion 49. Therefore, the first shaft holding portion 53 is formed such that a cross-sectional area of a remote portion of the first shaft holding portion 53, which is remote from the connecting portion 49, is smaller than a cross-sectional area of an adjacent portion of the first shaft holding portion 53, which is adjacent to the connecting portion 49, while the cross-sectional area of the remote portion and the cross-sectional area of the adjacent portion are perpendicular to the axis Ax.

The rib-shaped portion 47 radially outwardly projects from the tapered portion 61 of the first shaft holding portion 53. The rib-shaped portion 47 is formed in the tapered portion 61 of the first shaft holding portion 53 at a location that includes the weld-line portion 51. In other words, the rib-shaped portion 47 is formed in the tapered portion 61 at the location that is on the opposite side of the axis Ax of the output gear 30 which is opposite to the gate mark 50 located on the radially inner side of the toothed portion 58. The rib-shaped portion 47 has a predetermined width in the circumferential direction and radially outwardly projects from the tapered portion 61. Therefore, the rib-shaped portion 47 has a wall thickness which is measured in the radial direction and is larger than a wall thickness of the tapered portion 61 measured in the radial direction. A radially outer surface of the rib-shaped portion 47 and a radially outer surface of the large-diameter portion 55 are continuous with each other.

Next, flows of the molten resin at the time of resin injection molding of the output gear 30 of the fourth embodiment will be described.

FIGS. 19 to 21 are explanatory diagrams for explaining how the molten resin is filled particularly in the center portion 46 and the rib-shaped portion 47 at the time of the resin injection molding of the output gear 30. In FIGS. 19 to 21, an inner wall of the cavity of the mold 70 and the output shaft 22 are indicated by solid lines. Furthermore, in FIGS. 19 to 21, in order to show the molten resin filled in the cavity of the mold 70 in an easy-to-understand manner, the molten resin is indicated with a resin hatching pattern although it is not a cross-section.

As shown in FIG. 19, at the time of the resin injection molding of the output gear 30, the molten resin, which is injected into the cavity from the gate of the mold 70, flows from the toothed portion 58 side, at which the gate is placed, toward the toothless portion 59 side in the resin portion while bypassing the output shaft 22. Then, as shown by arrows in FIG. 19, the left molten resin flow and the right molten resin flow, which are conducted to the toothless portion 59 side while bypassing the output shaft 22, gradually approach each other. At this time, the molten resin is quickly filled in large volume portions of the cavity of the mold 70, each of which has a relatively large volume, and the molten resin is later filled in small volume portions of the cavity of the mold 70, each of which has a relatively small volume.

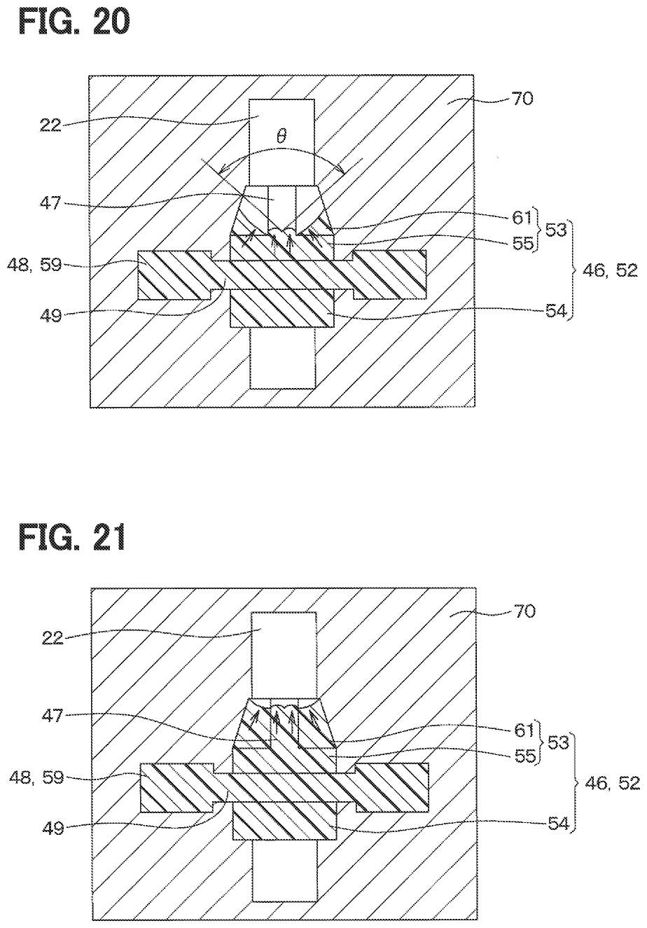

Next, as indicated by arrows in FIG. 20, the left molten resin flow and the right molten resin flow, which are conducted to the toothless portion 59 side in the resin portion, meet at the large-diameter portion 55 of the center portion 46, the connecting portion 49 and the outer peripheral portion 48. Then, as indicated by arrows in FIG. 20, the molten resin is mainly filled from the large-diameter portion 55 into the rib-shaped portion 47 which has a larger cross-sectional area in comparison to the tapered portion 61. In the rib-shaped portion 47, the molten resin is progressively filled from the large-diameter portion 55 side toward a distal end side of the rib-shaped portion 47. At that time, the meeting angle θ of the left and right flows of the molten resin, which meet at the rib-shaped portion 47, becomes a relatively large angle.

Subsequently, as shown in FIG. 21, the merged molten resin flow, which is merged at the rib-shaped portion 47, is progressively filled into the distal end portion (i.e., in a direction away from the large-diameter portion 55) at the earlier time than the time of filling the molten resin into the tapered portion 61 or almost at the same time as the time of filling the molten resin into the tapered portion 61. After the time of fully filling the molten resin into the rib-shaped portion 47 or almost at the same time as the time of fully filling the molten resin into the rib-shaped portion 47, the molten resin is fully filled into the tapered portion 61 located on the left and right sides of the rib-shaped portion 47. Therefore, the left and right flows of the molten resin are reliably joined at the weld-line portion 51 formed at the rib-shaped portion 47. Then, after the molten resin is cooled and solidified in the mold 70, the mold 70 is opened, and the output gear 30 is taken out from the mold 70.

The fourth embodiment described above can also achieve the functions and advantages which are similar to those of the first embodiment.

Furthermore, in the fourth embodiment, the rib-shaped portion 47 is formed such that the rib-shaped portion 47 radially outwardly projects from the tapered portion 61 of the first shaft holding portion 53. Therefore, during the resin injection molding, in the first shaft holding portion 53, the molten resin is filled from the large-diameter portion 55 to the rib-shaped portion 47 at the early stage, and the molten resin is filled in the distal end of the tapered portion 61 later. Thereby, the meeting angle of the flows of the molten resin, which is filled into the rib-shaped portion 47, becomes large at the end part of the rib-shaped portion 47 which is opposite to the connecting portion 49, so that the strength of the weld-line portion 51 formed at the rib-shaped portion 47 can be increased.

### Fifth Embodiment

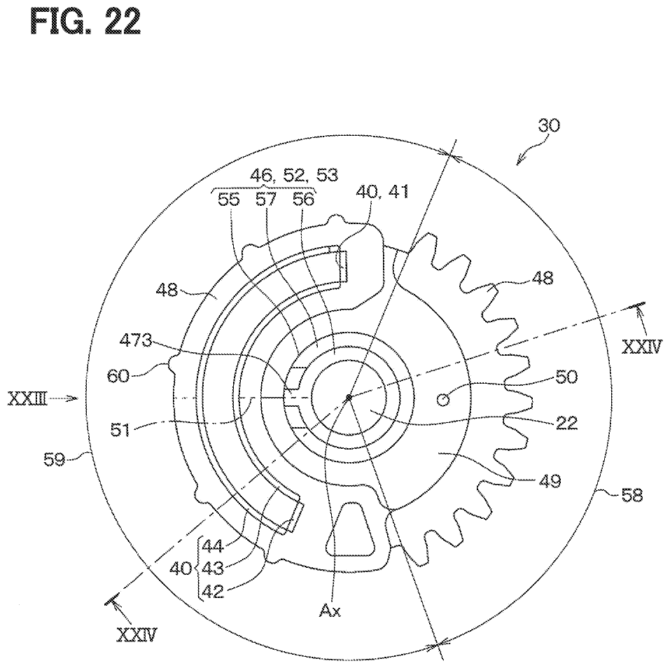

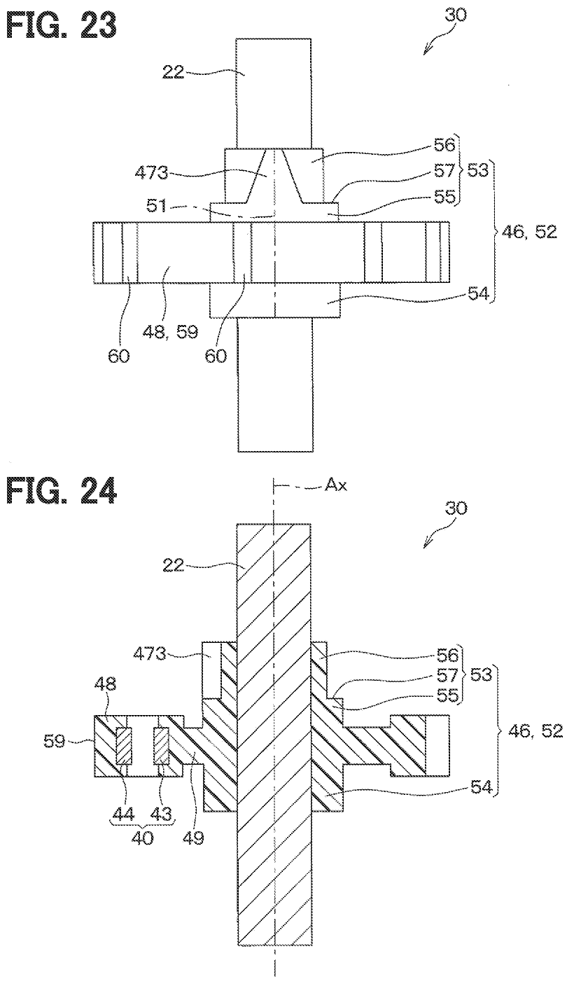

As shown in FIGS. 22 to 24, in the fifth embodiment, the first shaft holding portion 53 has the large-diameter portion 55 and the small-diameter portion 56. A rib-shaped portion 473 is formed in the small-diameter portion 56 of the first shaft holding portion 53 at the location which includes the weld-line portion 51. A width of the rib-shaped portion 473, which is measured in the circumferential direction, is progressively reduced in a direction away from the large-diameter portion 55 to progressively reduce the cross-sectional area of the rib-shaped portion 474.

Even in the structure of the rib-shaped portion 473 of the fifth embodiment, like in the first embodiment, the meeting angle of the flows of the molten resin can become large at the rib-shaped portion 473. Further, by forming the rib-shaped portion 473 in this way, the rib-shaped portion 473, which is the last filling portion at the time of the resin injection molding, is filled with the molten resin earlier, and the bonding force of the filled resin is increased. Thereby, the strength of the weld-line portion 51 formed in the rib-shaped portion 473 can be increased.

### Sixth Embodiment

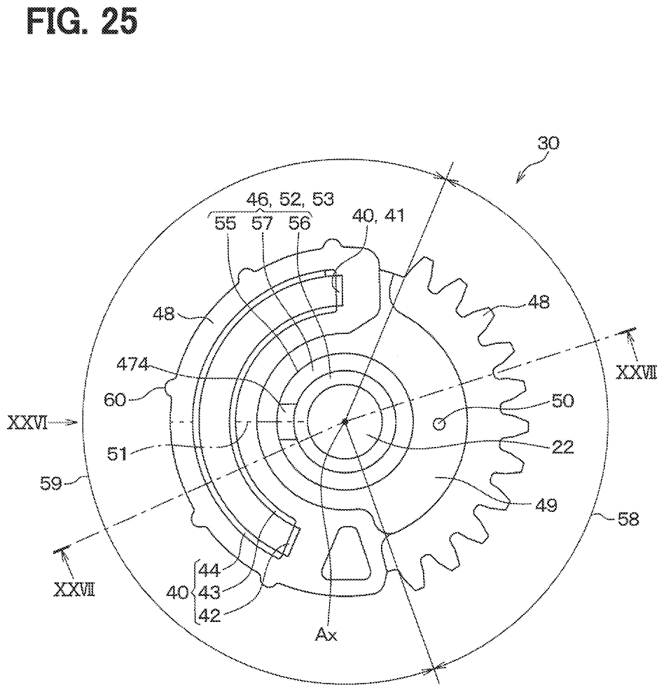

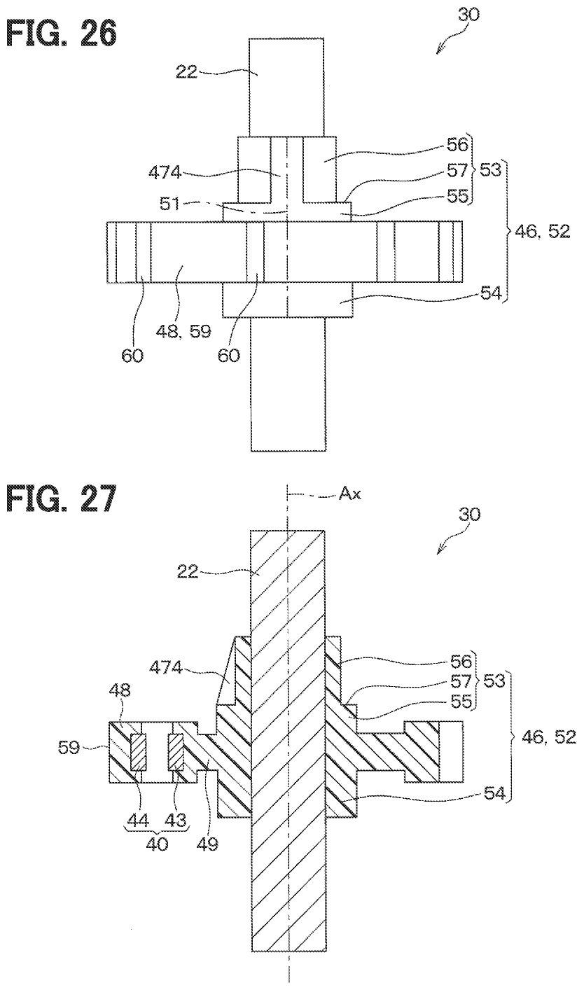

As shown in FIGS. 25 to 27, in the sixth embodiment, the first shaft holding portion 53 also has the large-diameter portion 55 and the small-diameter portion 56. A rib-shaped portion 474 is formed in the small-diameter portion 56 of the first shaft holding portion 53 at the location which includes the weld-line portion 51. A width of the rib-shaped portion 474, which is measured in the radial direction, is progressively reduced in a direction away from the large-diameter portion 55 to progressively reduce the cross-sectional area of the rib-shaped portion 474.

Even in the structure of the rib-shaped portion 474 of the sixth embodiment, like in the first embodiment, the meeting angle of the flows of the molten resin can become large at the rib-shaped portion 474. Further, by forming the rib-shaped portion 474 in this way, the rib-shaped portion 474, which is the last filling portion at the time of the resin injection molding, is filled with the molten resin earlier, and the bonding force of the filled resin is increased. Thereby, the strength of the weld-line portion 51 formed in the rib-shaped portion 474 can be increased.

### Seventh Embodiment

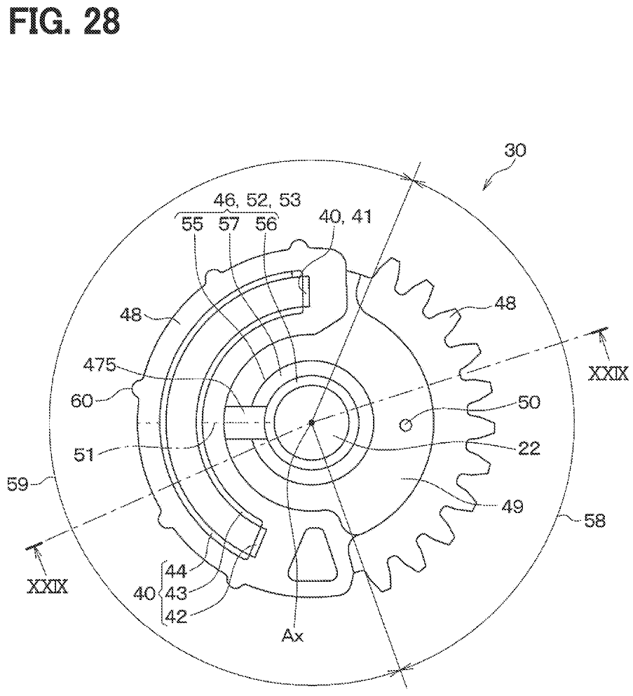

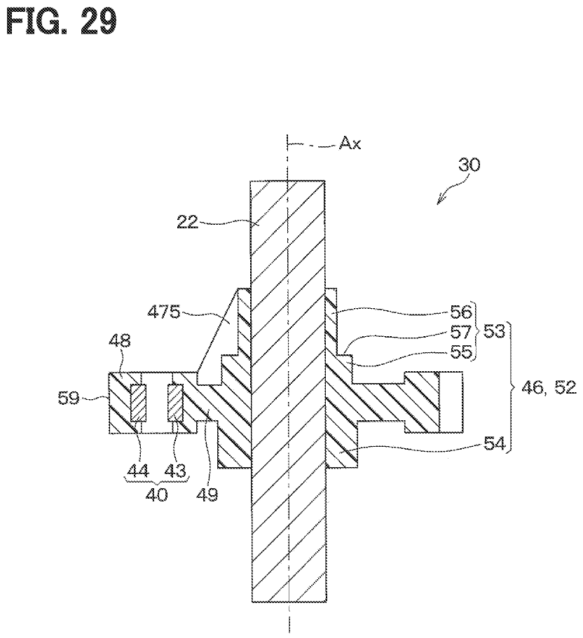

As shown in FIGS. 28 and 29, in the seventh embodiment, the first shaft holding portion 53 also has the large-diameter portion 55 and the small-diameter portion 56. A rib-shaped portion 475 extends along: a portion of the outer peripheral portion 48, at which the magnetic circuit device 40 is installed; the connecting portion 49; and the first shaft holding portion 53. In other words, the rib-shaped portion 475 extends along the portion of the outer peripheral portion 48, the connecting portion 49 and the first shaft holding portion 53 at the location that is on the opposite side of the axis Ax of the output gear 30 which is opposite to the gate mark 50 located on the radially inner side of the toothed portion 58. The rib-shaped portion 475 has a predetermined width in the circumferential direction and radially outwardly projects from the first shaft holding portion 53. Alternatively, it can be said that the rib-shaped portion 475 is provided so as to project in the axial direction from the connecting portion 49 and the stepped portion 57. An axial surface (alternatively the axial surface can be also said to be a radially outer surface) of the rib-shaped portion 475 is a sloped surface that is sloped such that a distance between the connecting portion 49 and the sloped surface is progressively reduced from the output shaft 22 side toward the radially outer side. This sloped surface connects between an end part of the outer peripheral portion 48, which is located on the output shaft 22 side, and the upper end part of the first shaft holding portion 53.

Even with the structure of the rib-shaped portion 475 of the seventh embodiment described above, the same functions and advantages as those of the first embodiment can be obtained. Furthermore, in the seventh embodiment, it is possible to further increase the strength of the toothless portion 59 and limit warping of the output gear 30 by increasing the cross-sectional area of the weld-line portion 51.

### Eighth Embodiment

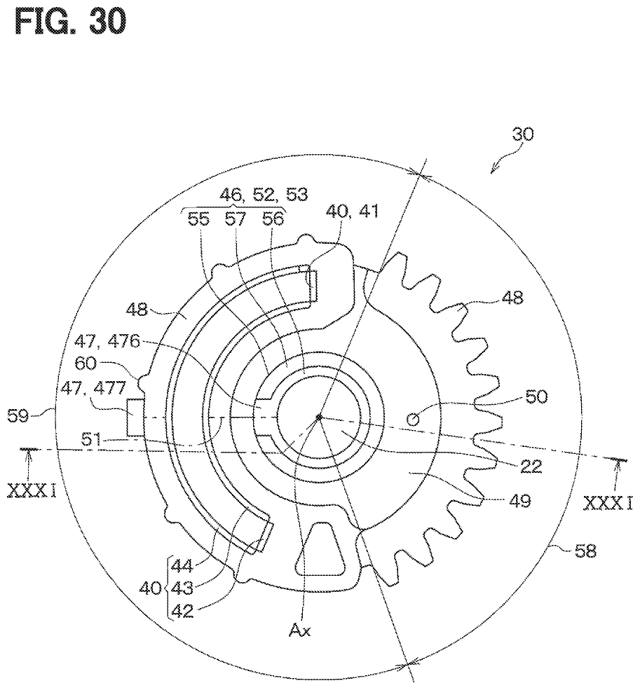

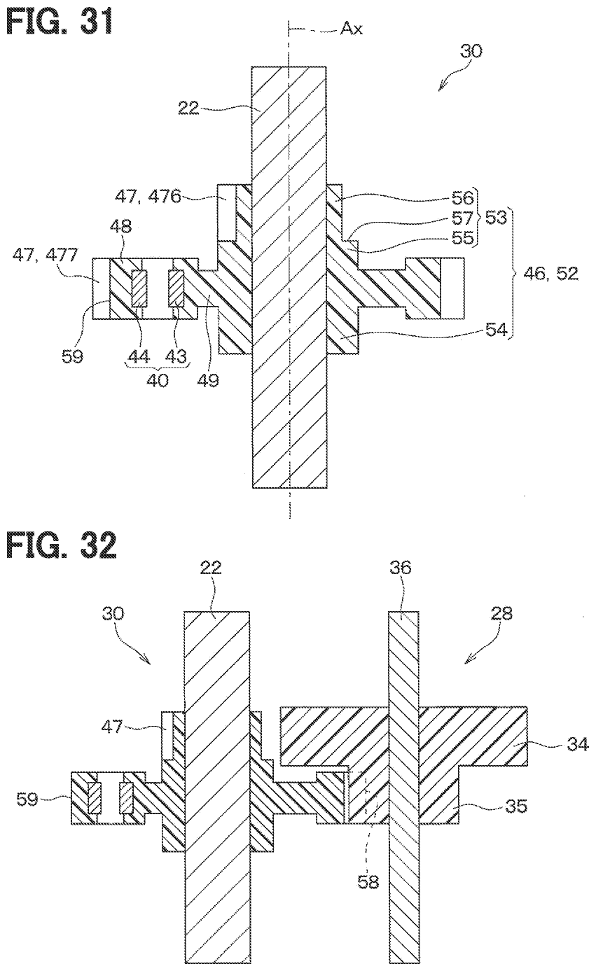

As shown in FIGS. 30 and 31, in the eighth embodiment, the rib-shaped portion 47 is also formed in the toothless portion 59 of the outer peripheral portion 48 in addition to the rib-shaped portion 47 in the small-diameter portion 56 of the first shaft holding portion 53. The rib-shaped portion 47, which is formed in the small-diameter portion 56 of the first shaft holding portion 53, will be referred to as a center rib-shaped portion 476, and the rib-shaped portion 47, which is formed in the toothless portion 59 of the outer peripheral portion 48, will be referred to as an outer peripheral rib-shaped portion 477. The outer peripheral rib-shaped portion 477 radially outwardly projects from the toothless portion 59 of the outer peripheral portion 48.

Each of the center rib-shaped portion 476 and the outer peripheral rib-shaped portion 477 is located at the location that is on the opposite side of the axis Ax of the output gear 30 which is opposite to the gate mark 50 located on the radially inner side of the toothed portion 58.

Even with the structure of the rib-shaped portion 47 of the eighth embodiment, the same functions and advantages as those of the first embodiment can be obtained. Furthermore, in the eighth embodiment, it is possible to increase the strength of the weld-line portion 51 formed in the toothless portion 59 of the outer peripheral portion 48.

As a modification of the eighth embodiment, the output gear 30 may be formed such that the center rib-shaped portion 476 is not formed in the output gear 30, and only the outer peripheral rib-shaped portion 477 is formed in the output gear 30.

### Ninth Embodiment

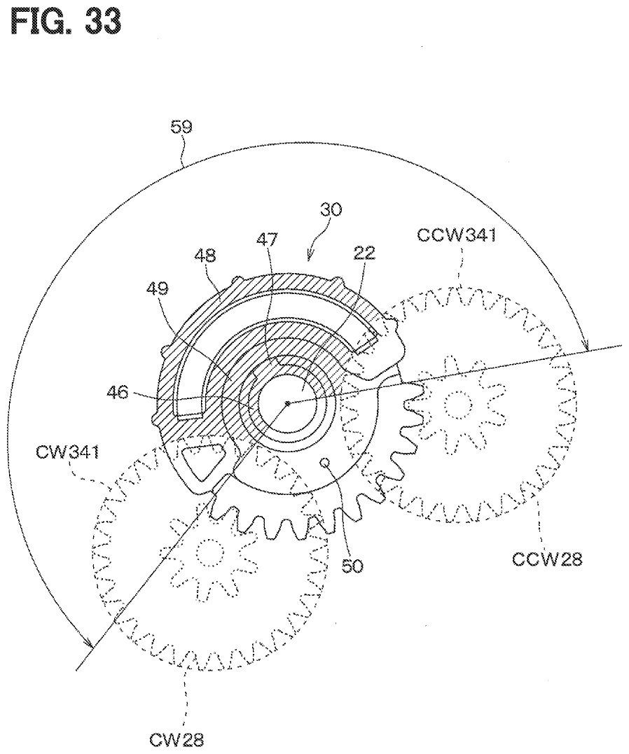

A ninth embodiment will be described with reference to FIGS. 32 and 33. The ninth embodiment defines a range in which the rib-shaped portion 47 can be formed in the output gear 30.

FIG. 32 is a cross-sectional view of the output gear 30 and the second intermediate gear 28 of the speed reducer 25. As discussed above, the second intermediate gear 28 is the two-stage gear that includes the second large gear 34 and the second small gear 35 while the diameter of the second small gear 35 is smaller than the diameter of the second large gear 34. Hereinafter, in the description of the ninth embodiment, the second intermediate gear 28, the second large gear 34 and the second small gear 35 will be simply referred to as an intermediate gear 28, a large gear 34 and a small gear 35, respectively.

FIG. 33 is an explanatory diagram for explaining a range in which the rib-shaped portion 47 can be formed in the output gear 30. In FIG. 33, a reference sign CW28 indicates a relative position of the intermediate gear 28 relative to the output gear 30 in a state where the intermediate gear 28 is most rotated in a clockwise direction in a meshed range, in which the toothed portion 58 of the output gear 30 and the small gear 35 of the intermediate gear 28 are meshed with each other. Furthermore, a reference sign CCW28 indicates a relative position of the intermediate gear 28 relative to the output gear 30 in a state where the intermediate gear 28 is most rotated in a counterclockwise direction in a meshed range, in which the toothed portion 58 of the output gear 30 and the small gear 35 of the intermediate gear 28 are meshed with each other. Also, in FIG. 33, in order to clearly show the range in which the rib-shaped portion 47 can be formed in the resin portion of the output gear 30, this range is indicated by providing a hatching pattern to the output gear 30 although this hatching pattern does not indicate a cross-section of the output gear 30.

In the resin portion of the output gear 30, the rib-shaped portion 47 can be formed in the range that satisfies the following three conditions.

As a first condition, the range is in at least one of the center portion 46, the connecting portion 49 and the outer peripheral portion 48 and is on a radially inner side of the toothless portion 59.

As a second condition, the range is on an outer side of an addendum circle CW341 of the large gear 34 of the intermediate gear 28 in a state where the intermediate gear 28 is most rotated in the clockwise direction while the toothed portion 58 of the output gear 30 and the small gear 35 of the intermediate gear 28 are meshed with each other.

As a third condition, the range is on an outer side of an addendum circle CCW341 of the large gear 34 of the intermediate gear 28 in a state where the intermediate gear 28 is most rotated in the counterclockwise direction while the toothed portion 58 of the output gear 30 and the small gear 35 of the intermediate gear 28 are meshed with each other.

In the ninth embodiment described above, by forming the rib-shaped portion 47 in the range, which satisfies the first to third conditions described above, in the resin portion of the output gear 30, it is possible to limit interference between the rib-shaped portion 47 and the intermediate gear 28.

### Other Embodiments

The present disclosure is not limited to the above embodiments, and the above embodiments may be changed as appropriate. Furthermore, the above embodiments are not unrelated to each other and can be appropriately combined unless the combination is clearly impossible. Furthermore, needless to say, in each of the above embodiments, the components of the embodiment are not necessarily essential except when it is clearly indicated that they are essential and when they are clearly considered to be essential in principle. In the above embodiments, when the numerical values, such as the number, numerical value, quantity, range, etc. of the components of the embodiment(s) are mentioned, the numerical values are not limited to those described in the embodiment(s) except when it is clearly indicated that the numeric values are essential and when the numeric values are clearly considered to be essential in principle. In each of the above embodiments, when a shape, a positional relationship, etc. of the component(s) is mentioned, the shape, positional relationship, etc. are not limited to those described in the embodiment unless otherwise specified or limited in principle to the those described in the embodiment.

(1) In each of the above embodiments, as the example of the actuator 1, there is described the wastegate valve actuator for driving the boost pressure control valve of the supercharger 2. However, the present disclosure is not limited to this. The actuator 1 may be applied to various applications such as an actuator for an electronic throttle valve for driving an electronic throttle valve, or an actuator for an exhaust gas recirculation (EGR) valve for driving a valve that opens and closes an EGR passage.

(2) In each of the above embodiments, the output gear 30 of the speed reducer 25 has been described as an example of at least a gear formed by resin injection molding, but the present disclosure is not limited to this. The gear formed by the resin injection molding can be applied to the intermediate gears 27, 28 of the speed reducer 25 if the intermediate gears 27, 28 have the toothless portion 59 and the toothed portion 58.

(3) In each of the above embodiments, the output gear 30 includes the insert component in the center portion 46. However, the present disclosure is not limited to this. The output gear 30 may have a component coupling hole in the center portion 46 in place of the insert component. A component, such as the output shaft 22, may be inserted into and coupled to the component coupling hole.

(4) In each of the above embodiments, the output gear 30 has the first shaft holding portion 53 and the second shaft holding portion 54 formed in the center portion 46. However, the present disclosure is not limited to this. The output gear 30 may form only the first shaft holding portion 53 in the center portion 46 of the output shaft 22 or may form only the second shaft holding portion 54 in the center portion 46 of the output shaft 22. Alternatively, the output gear 30 may be formed such that the thickness of the center portion 46 and the thickness of the connecting portion 49 are set to be equal to each other without forming the shaft holding portion 52 at the center portion 46 of the output shaft 22.

(5) In each of the above embodiments, the output gear 30 forms the gate mark 50 in the connecting portion 49 located on the radially inner side of the toothed portion 58. However, the present disclosure is not limited to this. The gate mark 50 of the output gear 30 may be formed in any of the center portion 46, the connecting portion 49, and the outer peripheral portion 48 as long as the gate mark 50 is located on the radially inner side of the toothed portion 58.

What is claimed is:

1. An actuator comprising a speed reducer configured to output a drive force generated through rotation by a drive device after reducing a rotational speed of the rotation outputted from the drive device, wherein the speed reducer includes at least a gear that is formed by resin injection molding, wherein the gear has:
an insert component or a component coupling hole, wherein the insert component or the component coupling hole is located at a location that includes a rotational axis of the gear;
a center portion that surrounds the insert component or the component coupling hole;
an outer peripheral portion that is formed at an outer periphery of the gear and includes a toothed portion and a toothless portion;
a connecting portion that connects between the center portion and the outer peripheral portion;
a gate mark of the resin injection molding, wherein the gate mark is formed in at least one of the center portion, the connecting portion and the outer peripheral portion at a location which is on a radially inner side of the toothed portion;
a weld-line portion that is a portion where flows of molten resin meet at a time of the resin injection molding, wherein the weld-line portion is formed in at least one of the center portion, the connecting portion and the outer peripheral portion at a location which is on a radially inner side of the toothless portion; and
a rib-shaped portion that is formed in at least one of the center portion, the connecting portion and the outer peripheral portion at a location which includes the weld-line portion, wherein the rib-shaped portion has a wall thickness that is larger than a wall thickness of another circumferential portion which is other than the rib-shaped portion and is located on a side of the rib-shaped portion in a circumferential direction.

2. The actuator according to claim 1, wherein:
the insert component or a component coupled to the component coupling hole is an output shaft that is configured to transmit a torque to a driven body located at an outside of the actuator; and
a shaft holding portion is formed in the center portion such that the shaft holding portion projects on one side or another side of the connecting portion in an axial direction of the rotational axis and holds the output shaft.

3. The actuator according to claim 2, wherein:
the output shaft is configured to transmit the torque to the driven body from one end portion of the output shaft located along the rotational axis of the gear; and
the shaft holding portion includes a first shaft holding portion, which projects on the one side of the connecting portion in the axial direction of the rotational axis, and a second shaft holding portion, which projects on the another side of the connecting portion in the axial direction of the rotational axis.

4. The actuator according to claim 3, wherein a length of the first shaft holding portion, which is measured in the axial direction of the rotational axis, is longer than a length of the second shaft holding portion, which is measured in the axial direction of the rotational axis.

5. The actuator according to claim 3, wherein the rib-shaped portion is formed at the first shaft holding portion.

6. The actuator according to claim 3, wherein the rib-shaped portion is formed at the second shaft holding portion.

7. The actuator according to claim 2, wherein:
the shaft holding portion is formed such that a cross-sectional area of a remote portion of the shaft holding portion, which is remote from the connecting portion, is smaller than a cross-sectional area of an adjacent portion of the shaft holding portion, which is adjacent to the connecting portion, while the cross-sectional area of the remote portion and the cross-sectional area of the adjacent portion are perpendicular to the rotational axis; and
the rib-shaped portion is formed at the remote portion which is remote from the connecting portion.

8. The actuator according to claim 2, wherein:
the shaft holding portion has a tapered portion that has a cross-sectional area which is perpendicular to the rotational axis and is progressively reduced in a direction away from the connecting portion; and
the rib-shaped portion radially outwardly projects from the tapered portion.

9. The actuator according to claim 2, wherein:
the shaft holding portion has:
a large-diameter portion that is located at a side of the shaft holding portion where the connecting portion is placed;
a small-diameter portion that has a diameter smaller than a diameter of the large-diameter portion and is located on an opposite side of the large-diameter portion which is opposite to the connecting portion; and
a stepped portion that connects between the large-diameter portion and the small-diameter portion; and
the rib-shaped portion radially outwardly projects from the small-diameter portion.

10. The actuator according to claim 9, wherein a radially outer surface of the rib-shaped portion and a radially outer surface of the large-diameter portion form a continuous surface.

11. The actuator according to claim 2, wherein the rib-shaped portion is formed such that a cross-sectional area of the rib-shaped portion, which is perpendicular to the rotational axis, is progressively reduced in a direction away from the connecting portion.

12. The actuator according to claim 1, wherein the gate mark is formed in the connecting portion or the outer peripheral portion only at one location that is on the radially inner side of the toothed portion.

13. The actuator according to claim 1, further comprising a magnetic circuit device located at the toothless portion of the outer peripheral portion.

14. The actuator according to claim 13, wherein the rib-shaped portion extends along:
a portion of the outer peripheral portion, at which the magnetic circuit device is located;
the connecting portion; and
the center portion.

15. The actuator according to claim 1, wherein the rib-shaped portion radially outwardly projects from the toothless portion of the outer peripheral portion.

16. The actuator according to claim 1, wherein:
the speed reducer further includes a two-stage gear that has a small gear, which is meshed with the toothed portion of the gear, and a large gear, which has a diameter larger than a diameter of the small gear and is formed integrally with the small gear in one-piece; and
the rib-shaped portion is formed in at least one of the center portion, the connecting portion and the outer peripheral portion in a range that is on:
the radially inner side of the toothless portion;
an outer side of an addendum circle of the large gear of the two-stage gear in a state where the two-stage gear is most rotated in a clockwise direction while the toothed portion of the gear and the small gear of the two-stage gear are meshed with each other; and
an outer side of an addendum circle of the large gear of the two-stage gear in a state where the two-stage gear is most rotated in a counterclockwise direction while the toothed portion of the gear and the small gear of the two-stage gear are meshed with each other.

17. An actuator comprising a speed reducer configured to output a drive force generated through rotation by a drive device after reducing a rotational speed of the rotation outputted from the drive device, wherein the speed reducer includes at least a gear that is formed by resin injection molding, wherein the gear has:
an insert component or a component coupling hole, wherein the insert component or the component coupling hole is located at a location that includes a rotational axis of the gear;
a center portion that surrounds the insert component or the component coupling hole;
an outer peripheral portion that is formed at an outer periphery of the gear and includes a toothed portion and a toothless portion;
a connecting portion that connects between the center portion and the outer peripheral portion;
a gate mark of the resin injection molding, wherein the gate mark is formed in at least one of the center portion, the connecting portion and the outer peripheral portion at a location which is on a radially inner side of the toothed portion; and
a rib-shaped portion that is formed in the center portion, the outer peripheral portion or the connecting portion at a location which includes an opposite location that is on an opposite side of the rotational axis which is opposite to the gate mark, wherein the rib-shaped portion has a wall thickness that is larger than a wall thickness of another circumferential portion which is other than the rib-shaped portion and is located on a side of the rib-shaped portion in a circumferential direction.

18. The actuator according to claim 1, wherein the actuator is configured to drive a boost pressure control valve of a supercharger.
